(19) United States
(12) Patent Application Publication
(10) Pub. No.: US 2018/0276748 A1
(43) Pub. Date: Sep. 27, 2018

(54) OPTIMIZATION METHOD AND APPARATUS FOR CREDIT SCORE OF USER

(71) Applicant: TENCENT TECHNOLOGY (SHENZHEN) COMPANY LIMITED, Shenzhen (CN)

(72) Inventors: Peixuan CHEN, Shenzhen (CN); Qian CHEN, Shenzhen (CN); Lin LI, Shenzhen (CN); Zhibin LIU, Shenzhen (CN)

(21) Appl. No.: 15/996,202

(22) Filed: Jun. 1, 2018

Related U.S. Application Data
(63) Continuation of application No. PCT/CN2017/087261, filed on Jun. 6, 2017.

(30) Foreign Application Priority Data
Jun. 6, 2016 (CN) 201610396866.8

(51) Int. Cl. G06Q 40/02; G06F 17/11; G06Q 50/00

(52) U.S. Cl. CPC G06Q 40/025; G06Q 50/01; G06F 17/11

(57) ABSTRACT

An optimization method for obtaining a user credit score is provided. The method includes obtaining initial credit scores of users in multiple social-network user sets; obtaining initial credit scores of the social-network user sets according to the initial credit scores of the users; and determining a social-network relationship between each two social-network user sets according to a social-network relationship between the users in each two social-network user sets. The method also includes, according to a credit score of at least one social-network user set having a social-network relationship with a target social-network user set and the social-network relationship between the at least one social-network user set and the target social-network user set, optimizing and adjusting a credit score of the target social-network user set; and correcting credit scores of users in the target social-network user set according to the optimized and adjusted credit score of the target social-network user set.

### RELATED APPLICATION

This application is a continuation application of PCT Patent Application No. PCT/CN2017/087261, filed on Jun. 6, 2017, which claims priority to Chinese Patent Application No. 201610396866.8, entitled “OPTIMIZATION METHOD AND APPARATUS FOR CREDIT SCORE OF USER” filed with the Patent Office of China on Jun. 6, 2016, content of all of which is incorporated by reference in its entirety.

### FIELD OF THE TECHNOLOGY

This application relates to the field of Internet technologies and, in particular, to an optimization method and apparatus for obtaining a user credit score.

### BACKGROUND OF THE DISCLOSURE

As Internet technologies rapidly develop in recent years, people process an increasing number of data services using the Internet, and credit assessment of users also becomes a focused problem in the field of Internet technologies.

In the existing technology, generally, to obtain credit assessment of a user, personal information of the user is collected, and then a default risk of the user is predicted by using a statistical model or some prediction algorithms of machine learning, for example, a frequently-used FICO credit score system and a Zestfinace credit rating system. However, in an existing credit score mechanism, only information of the user's own dimension is used. If the personal information of the user is collected incompletely or mistakenly, it is very difficult to implement accurate credit rating for the user.

The disclosed methods and systems are directed to solve one or more problems set forth above and other problems.

### SUMMARY

In view of this, embodiments of this application provide an optimization method and apparatus for a credit score of a user, to effectively increase the accuracy of the credit score of the user.

According to one aspect of the present disclosure, an optimization method for obtaining a user credit score is provided. The method includes obtaining initial credit scores of users in multiple social-network user sets; obtaining initial credit scores of the social-network user sets according to the initial credit scores of the users; and determining a social-network relationship between each two social-network user sets according to a social-network relationship between the users in each two social-network user sets. The method also includes, according to a credit score of at least one social-network user set having a social-network relationship with a target social-network user set and the social-network relationship between the at least one social-network user set and the target social-network user set, optimizing and adjusting a credit score of the target social-network user set; and correcting credit scores of users in the target social-network user set according to the optimized and adjusted credit score of the target social-network user set.

According to another aspect of the present disclosure, a non-transitory computer-readable storage medium is provided. The non-transitory computer-readable storage medium stores computer program instructions executable by at least one processor to perform: obtaining initial credit scores of users in multiple social-network user sets; obtaining initial credit scores of the social-network user sets according to the initial credit scores of the users in the social-network user sets; determining a social-network relationship between each two social-network user sets according to a social-network relationship between the users in the each two social-network user sets; according to a credit score of at least one social-network user set having a social-network relationship with a target social-network user set and the social-network relationship between the at least one social-network user set and the target social-network user set, optimizing and adjusting a credit score of the target social-network user set; and correcting credit scores of users in the target social-network user set according to the optimized and adjusted credit score of the target social-network user set.

Other aspects of the present disclosure can be understood by those skilled in the art in light of the description, the claims, and the drawings of the present disclosure.

### BRIEF DESCRIPTION OF THE DRAWINGS

To describe the technical solutions in the embodiments of the present disclosure more clearly, the following briefly describes the accompanying drawings. Apparently, the accompanying drawings in the following description show merely some embodiments of the present disclosure, and a person of ordinary skill in the art may derive other drawings from these accompanying drawings without creative efforts.

FIG. 1 is a schematic flowchart of an optimization method for a credit score of a user according to an embodiment of the present disclosure;

FIG. 2 is a schematic diagram of layered processing of a social-network relationship of a user according to an embodiment of the present disclosure;

FIG. 3 is a schematic flowchart of performing optimization and iteration on a credit score of a user set according to an embodiment of the present disclosure;

FIG. 4 is a schematic flowchart of an optimization method for a credit score of a user according to another embodiment of the present disclosure;

FIG. 5 is a schematic flowchart of performing optimization and iteration on a credit score of a user in a target social-network user set according to an embodiment of the present disclosure;

FIG. 6 is a schematic structural diagram of an optimization apparatus for a credit score of a user according to an embodiment of the present disclosure;

FIG. 7 is a schematic structural diagram of a set score optimization module according to an embodiment of the present disclosure;

FIG. 8 is a schematic structural diagram of a user score optimization module according to an embodiment of the present disclosure; and

FIG. 9 is a block diagram of a hardware structure of an optimization apparatus for a credit score of a user according to an embodiment of the present disclosure.

### DESCRIPTION OF EMBODIMENTS

The following describes the technical solutions in the embodiments of the present disclosure with reference to the accompanying drawings. Apparently, the described embodiments are some embodiments of the present disclosure rather than all of the embodiments. Other embodiments obtained by a person of ordinary skill in the art based on the embodiments of the present disclosure without creative efforts shall fall within the protection scope of the present disclosure.

The optimization method and apparatus for obtaining a user credit score in the embodiments of the present disclosure may be implemented in a computer system, such as a personal computer, a notebook computer, a smartphone, a tablet computer, or an e-reader, etc.

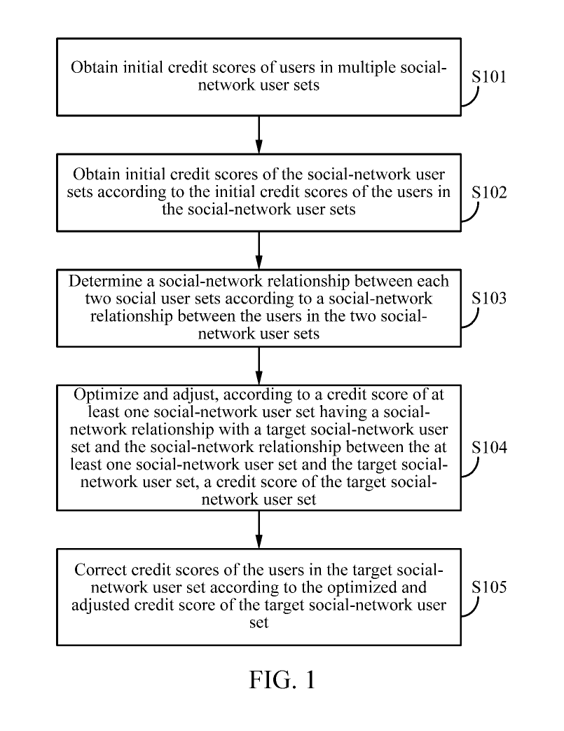

FIG. 1 is a schematic flowchart of an optimization method for obtaining a user credit score according to an embodiment of the present disclosure. As shown in FIG. 1, in this embodiment, the optimization method for obtaining a user credit score may include the following procedure.

S101: Obtaining initial credit scores of users in multiple social-network user sets.

Specifically, the initial credit scores of the users in the multiple social-network user sets may be imported into the optimization apparatus for obtaining a user credit score. Alternatively, the optimization apparatus for obtaining a user credit score may obtain personal information of the users, and perform credit scoring according to the personal information of the users and a specific predictive model, to obtain the initial credit scores of the users in the multiple social-network user sets. Alternatively, the optimization apparatus for obtaining a user credit score may obtain optimized credit scores of the users by implementing the present disclosure, and use the optimized credit scores as the initial credit scores of the users in the multiple social-network user sets. For example, when current credit scores are optimized, credit scores of the users that are obtained in a previous optimization may be used as initial credit scores in this optimization. The optimizing process of the credit scores of the users may be manually triggered by an administrator, or may be triggered according to an updating cycle or according to an event of adding a new user or social-network user set.

In an embodiment, if an initial credit score of a user is missing, an average score or a weighted average score of credit scores of other users who are social-network friends, colleagues, and relatives may be used as the initial credit score of the user. The weight value may be determined according to a closeness degree between the user and the other users or according to a frequency of social events occurring between the user and the other users.

The multiple social-network user sets may be sets or collections of users participating in different social-network groups. Users participating in a same social-network group belong to a social-network user set corresponding to the social-network group. Alternatively, the multiple social-network user sets may be obtained by performing division according to specific attributes of the users, for example, interests or geographical locations of the users. In one embodiment, in the social-network user sets, a same user does not exist in more than one set. That is, one user belongs to only one social-network user set.

S102: Obtaining initial credit scores of the social-network user sets according to the initial credit scores of the users in the social-network user sets.

In a specific implementation, an average score or a weighted average score of the initial credit scores of the users in a social-network user set may be used as an initial credit score of the social-network user set. That is,

$${S}_{i} = {\sum }_{j = 1}^{{n}_{i}} {s}_{j} / {n}_{i}$$

$$or$$

$${S}_{i} = {\sum }_{j = 1}^{{n}_{i}} {a}_{j} {s}_{j} / {n}_{i} ,$$

where Sᵢ is an initial credit score of a social-network user set, sⱼ is an initial credit score of a j^{th} user in the social-network user set, nᵢ is the quantity of users in the social-network user set, and aⱼ is a weighted value of the j^{th} user for a credit score of the social-network user set.

A weight value of each user may be determined according to social-network relationships between the user and other users in the social-network user set. For example, the user has four social friends in a social-network user set (six persons in total), and the weight value may be 4/(6−1)=0.8, and so on. Alternatively, the weight value of the user used for the credit score of the social-network user set may be determined according to a frequency of social events occurring between the user and other users in the social-network user set. Alternatively, the weight value of the user used for the credit score of the social-network user set may be determined jointly in combination of the above two manners.

S103: Based on social-network relationships between the users in each of two social-network user sets, determining a social-network relationship between the two social-network user sets.

The optimization apparatus for obtaining a user credit score in one embodiment may determine a social-network relationship between two social-network user sets according to social-network relationships between the users separately belonging to the two social-network user sets. For example, if a first user belonging to a first social-network user set has a social friend in a second social-network user set, a social-network relationship exists between the first social-network user set and the second social-network user set. Further, a closeness degree of the social-network relationship between the two social-network user sets may be quantified. For example, the closeness degree of the social-network relationship between the two social-network user sets may be quantified according to the number of users that are in the two social-network user sets and that are social friends of each other (the number of users or the number of social-network relationship pairs). The closeness degree may be consistent, that is, a bi-directional closeness degree between the two social-network user sets is quantified, or may be inconsistent, that is, a unidirectional closeness degree between the two social-network user sets is quantified.

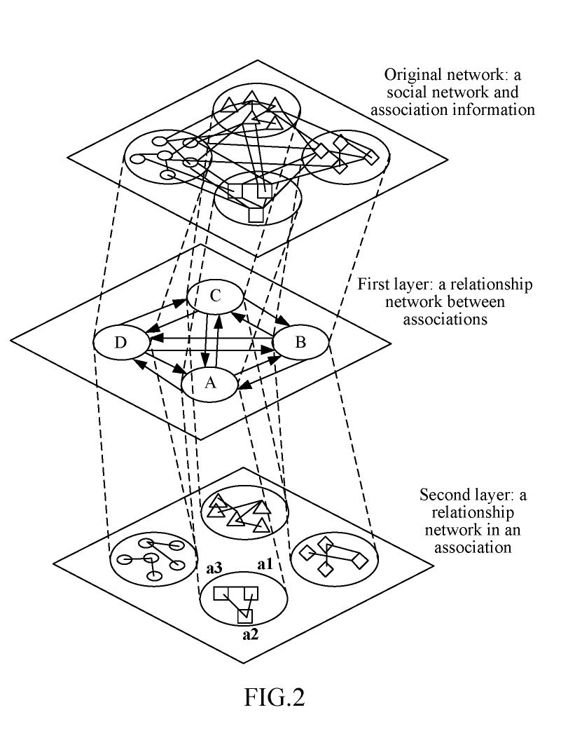

For example, social-network user sets (also referred to as associations) A, B, C, and D are obtained by means of layered processing of social-network relationships between users, as shown in FIG. 2. The number of users that are in the social-network user set A and that have social friends in the social-network user set B is determined, and the result from dividing the number of users having the social friends in the social-network user set B by the total number of users in the social-network user set A is quantified as a social closeness degree of the social-network user set A with the social-network user set B.

On the reversing direction, the result of dividing the number of users having social friends in the social-network user set A by a total number of users in the social-network user set B is quantified as a social closeness degree of the social-network user set B with the social-network user set A. A bi-directional closeness degree between the social-network user set A and the social-network user set B may be further calculated according to the social closeness degree of the social-network user set A with the social-network user set B in combination with the social closeness degree of the social-network user set B with the social-network user set A.

Subsequently, a social weight between the two social-network user sets may also be determined according to the closeness degree of the social-network relationship between the two social-network user sets that is obtained by means of quantification. That is, when a credit score of a target social-network user set is calculated, a weighted value of a credit score of the other social-network user set having the social-network relationship with the target social-network user set is considered. If a social-network relationship between two social-network user sets is closer, the probability that credit scores of the two social-network user sets are similar is higher. In other words, a credit score of a close social-network user set of the target social-network user set likely reflects the credit score of the target social-network user set. Therefore, when the credit score of the target social-network user set is optimized and adjusted, an impact factor (a reference weight) of the credit score of a close social-network user set should be set to a larger value.

In the layered processing of the social-network relationships shown in FIG. 2, social-network relationships between associations of a middle layer are obtained by performing processing according to cross-association (social-network user set) social-network relationships of users in original social-network relationships of an upper layer, and social-network relationships between users in an association are reserved as social-network relationships of the users in a lower-layer association.

S104: According to a credit score of at least one social-network user set having a social-network relationship with a target social-network user set and the social-network relationship between the at least one social-network user set and the target social-network user set, optimizing and adjusting the credit score of the target social-network user set.

According to S103, the social-network relationship between each two social-network user set is obtained. It may be considered that, the two social-network user sets having the social-network relationship may affect each other, or credit scores of the two social-network user sets having the social-network relationship may be used as reference of each other. Therefore, the optimization apparatus for obtaining a user credit score may optimize and adjust the credit score of the target social-network user set according to credit scores of all other social-network user sets having social-network relationships with the target social-network user set, to effectively avoid inaccurate credit score of the target social-network user set caused by that information of the users is collected incompletely or mistakenly. For example, an average value of the credit scores of the other social-network user sets having the social-network relationships with the target social-network user set as the optimized and adjusted credit score of the target social-network user set, or any value between an average value of the credit scores of the other social-network user sets having the social-network relationships with the target social-network user set and the initial credit score of the target social-network user set as the optimized and adjusted credit score of the target social-network user set.

Further, in an embodiment, the optimization apparatus for obtaining a user credit score may determine a social weight between each social-network user set and the target social-network user set according to the social-network relationship between the social-network user set and the target social-network user set, and optimize and adjust, according to the social weight between the at least one social-network user set and the target social-network user set and the credit score of the corresponding social-network user set, the credit score of the target social-network user set. That is, the social weight between each social-network user set and the target social-network user set is determined according to the closeness degree that is between the target social-network user set and each of the other social-network user sets and that is quantified by performing S103, and then the credit score of the target social-network user set is optimized and adjusted according to the credit score of each social-network user set having the social-network relationship with the target social-network user set and the social weight between the social-network user set and the target social-network user set, for example,

$${Q}_{i} = {\sum }_{k ∈ Nb ( i )} {e}_{ki} * {Q}_{k} ,$$

where Qᵢ is the credit score of the target social-network user set, Qₖ is a credit score of k^{th} social-network user set having a social-network relationship with the target social-network user set, eₖᵢ is the social weight between the k^{th} social-network user set and the target social-network user set, and

$${\sum }_{k ∈ Nb ( i )} {e}_{ki} * {Q}_{k}$$

represents a sum of products of a credit score of each social-network user set having a social-network relationship with the target social-network user set and the social weight between the corresponding social-network user set and the target social-network user set. This implementation is especially applicable to a situation in which a new target social-network user set is added while other social-network user sets are all optimized and adjusted. Only the target social-network user set is separately optimized and adjust without optimizing and adjusting other social-network user sets again.

The social weight between each of the social-network user sets and the target social-network user set may be obtained according to a ratio of users having social-network associated users in the social-network user sets to all users in the target social-network user set. For example, a same manner of S103 in which the closeness degree of the social-network relationship between the two social-network user sets is quantified is applied.

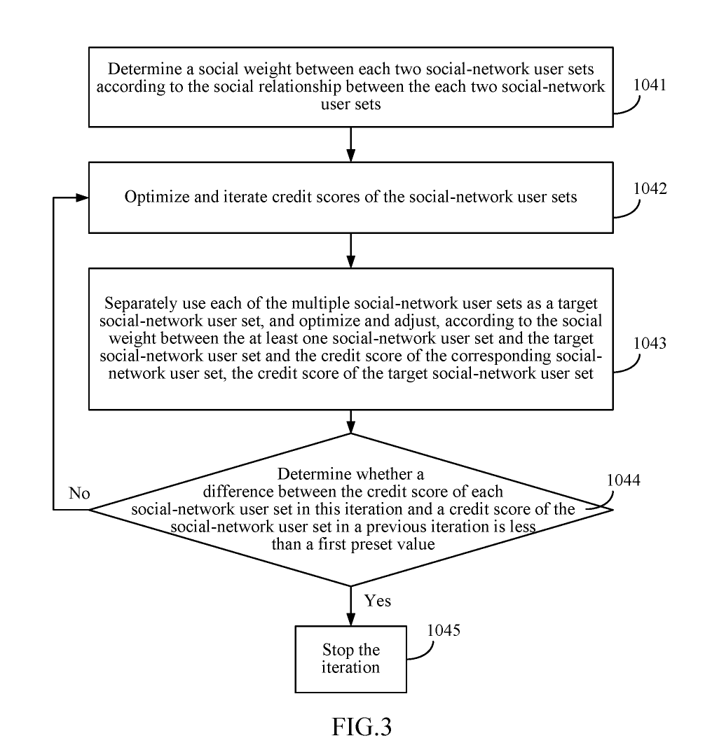

In another embodiment, the optimization method for obtaining a user credit score may optimize and iterate, according to a credit score of at least one social-network user set having a social-network relationship with the target social-network user set and the social-network relationship between the at least one social-network user set and the target social-network user set, a credit score of a social-network user set. A specific iteration procedure may be shown in FIG. 3.

S105: Correcting credit scores of the users in the target social-network user set according to the optimized and adjusted credit score of the target social-network user set.

Specifically, the optimization apparatus for obtaining a user credit score may correct the credit score of a user in the target social-network user set to any value between the initial credit score of the corresponding user and the optimized and adjusted credit score of the target social-network user set. For example, if information of a user in the target social-network user set is missing or goes wrong, the optimization apparatus for obtaining a user credit score may use the optimized and adjusted credit score of the target social-network user set as the corrected credit score of the user.

In an embodiment, the optimization apparatus for obtaining a user credit score may correct the credit scores of the users in the target social-network user set according to an adjustment value for optimizing and adjusting the credit score of the target social-network user set. For example, the credit scores of the users in the target social-network user set are corrected by using the following formula:

sⱼ′=sⱼ±(Qᵢ−Sᵢ),

where Qᵢ is the optimized and adjusted credit score of the target social-network user set, Sᵢ is the initial credit score of the target social-network user set, sⱼ is the initial credit score of a j^{th} user in the target social-network user set, and sⱼ′ is the corrected credit score of the j^{th} user in the target social-network user set.

The optimization apparatus for obtaining a user credit score may correct a corresponding ratio of the credit scores of the users in the target social-network user set according to an adjustment ratio for optimizing and adjusting the credit score of the target social-network user set.

Further, in an embodiment, the optimization apparatus for obtaining a user credit score may push product information for a user according to the corrected credit score of the corresponding user that is obtained by performing above steps, for example, push financial product information or fixed assets management product information; or monitor and manage a data service of a user according to the credit score of the corresponding user, for example, perform risk management on a loan service of the corresponding user, or propose a suggestion on management of current funds of the user.

FIG. 3 is a schematic flowchart of optimizing and iterating a credit score of a social-network user set according to an embodiment of the present disclosure. As shown in FIG. 3, the optimization and iteration process in this implementation may include the followings.

S1041: Determining a social weight between each two social-network user sets according to the social-network relationship between each two social-network user sets.

The social weight between each social-network user set and a target social-network user set may be determined according to a ratio between users having a social-network-associated user in each of the social-network user sets and the total users in the target social-network user set. For example, social-network user sets (also referred to as associations) A, B, C, and D are obtained by means of layered processing of social-network relationships between users that is shown in FIG. 2. The number of users that are in the social-network user set A and that having social friends in the social-network user set B is determined, and a result of dividing the number of users having the social friends in the social-network user set B by a total number of users in the social-network user set A as the social weight of the social-network user set A with the social-network user set B. For example, user a1 and user a2 in the social-network user set A each has a social friend in the social-network user set B, and a total number of the users in the social-network user set A is 3, so the social weight of the social-network user set A with the social-network user set B may be ⅔. That is, when a credit score of the social-network user set A is optimized, a social weight of a credit score of the social-network user set B is ⅔. On the other hand, a result of dividing the number of users having social friends in the social-network user set A by the total number of users in the social-network user set B as a social closeness degree of the social-network user set B with the social-network user set A. For example, two users in the social-network user set B also each has a social friend in the social-network user set A, and a total number of the users in the social-network user set B is 4, so the social weight of the social-network user set B with the social-network user set A may be 2/4=0.5. That is, when a credit score of the social-network user set B is optimized, a social weight of a credit score of the social-network user set A is 0.5.

S1042: Optimizing and iterating the credit scores of the social-network user sets.

S1043: Separately using each of the multiple social-network user sets as a target social-network user set, and optimizing and adjusting the credit score of the target social-network user set, according to the social weight between the at least one social-network user set and the target social-network user set and the credit score of the corresponding social-network user set.

That is, in each iteration, the credit score of each of the multiple social-network user sets is optimized and adjusted by using the following formula:

$${Q}_{i}^{( r )} = α + ( 1 - α ) {\sum }_{k ∈ Nb ( i )} {e}_{ki} * {Q}_{k}^{( r - 1 )} ,$$

where Qᵢ^{(r)} is the credit score of an i^{th} social-network user set in an r^{th} round of iteration, Qₖ^{(r-1)} is the credit score of a social-network user set having the social-network relationship with the i^{th} social-network user set in a (r−1)^{th} round of iteration, eₖᵢ is the social weight between the social-network user set having the social-network relationship with the i^{th} social-network user set and the i^{th} social-network user set,

$${\sum }_{k ∈ Nb ( i )} {e}_{ki} * {Q}_{k}^{( r - 1 )}$$

represents a sum of all products of the credit score of each social-network user set having the social-network relationship with the i^{th} social-network user set and the social weight between the corresponding social-network user set and the i^{th} social-network user set, and α is a preset damping factor.

S1044: Determining whether an absolute value of a difference between the credit score of each social-network user set in this iteration and a credit score of the social-network user set in a previous iteration is less than a first preset value, that is ∀i,|Qᵢ^{(r)}−Qᵢ^{(r-1)}|<β, and, if the formula is satisfied, performing S1045, otherwise performing S1042, that is, a next iteration.

S1045: Stopping the iteration, and the credit score of each social-network user set obtained by means of iteration is the credit score of the social-network user set obtained by optimization and adjustment.

It should be noted that the foregoing descriptions are only an example of an iteration algorithm. An algorithm for iterating the credit score of the social-network user set in the present disclosure should not be considered to be limited to the algorithm, and other algorithms such as a heat conduction network iteration algorithm may be applicable.

After the optimization apparatus for obtaining a user credit score in this embodiment calculates a credit score of a social-network user set to which the user belongs and performs optimization and adjustment, the apparatus corrects credit score of the user in the social-network user set according to the credit score of the social-network user set obtained by means of optimization and adjustment, to optimize the credit score of the user in combination with information of the social-network user set. Calculating the credit score of the user is no longer according to only personal information of the user, so that the accuracy of the credit score of the user can be effectively increased.

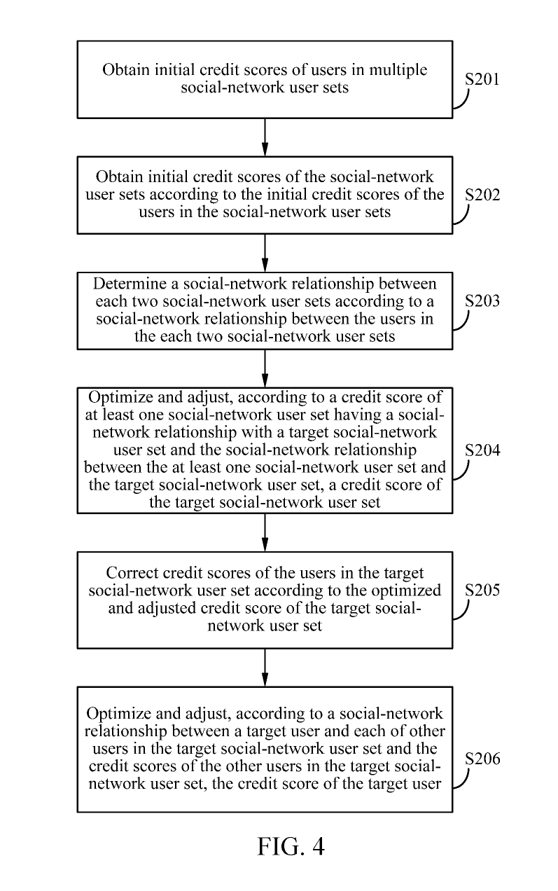

FIG. 4 is a schematic flowchart of an optimization method for obtaining a user credit score according to another embodiment of the present disclosure. As shown in FIG. 4, in one embodiment, the optimization method for obtaining a user credit score may include the following procedures.

S201: Obtaining initial credit scores of users in multiple social-network user sets.

S202: Obtaining initial credit scores of the social-network user sets according to the initial credit scores of the users in the social-network user sets.

S203: Determining a social-network relationship between each two social-network user sets according to social-network relationships between the users in each two social-network user sets.

S204: According to a credit score of at least one social-network user set having a social-network relationship with a target social-network user set and the social-network relationship between the at least one social-network user set and the target social-network user set, optimizing and adjusting the credit score of the target social-network user set.

S205: Correcting credit scores of the users in the target social-network user set according to the optimized and adjusted credit score of the target social-network user set.

S201 to S205 in one embodiment are the same as S101 to S105 in the previous embodiment, and details are not described again. A difference includes that, after the credit scores of the users in the target social-network user set are corrected according to the optimized and adjusted credit score of the target social-network user set, a user credit score in the target social-network user set is further optimized and adjusted.

S206: According to a social-network relationship between a target user and each of other users in the target social-network user set and the credit scores of the other users in the target social-network user set, optimizing and adjusting the credit score of the target user.

Social-network relationships between users in a lower-layer association are obtained by means of layered processing of social-network relationships that is shown in FIG. 2. For example, social-network relationships between users a1, a2, and a3 in a social-network user set A. In an embodiment, the reason for dividing the users a1, a2, and a3 into the social-network user set A may be excluded. For example, the users a1, a2, and a3 are divided into the social-network user set A according to a same social-network group in which the three users participate. When the social-network relationships between the users a1, a2, and a3 are considered, information that the users a1, a2, and a3 participate in a same social-network group may be ignored, and the social-network relationships between the users a1, a2, and a3 may be determined based on factors including, for example, whether a social-network friend relationship is established between the users, whether the users have a common interest, whether the users participated in social events at the same time, or whether the users are located in a same geographical location, etc.

If two users in a same social-network user set have a social-network relationship, it may be considered that the two users having the social-network relationship affect each other, or credit scores of the two users having the social-network relationship may be used as reference for each other. Therefore, an optimization apparatus for obtaining a user credit score may optimize and adjust the credit score of the target user according to a credit score of another user that belongs to a same social-network user set and that has a social-network relationship with the target user, thereby effectively avoiding the problem of inaccurate credit score of the target user when information of the user is collected incompletely or mistakenly. For example, an average value of the credit scores of all other users having the social-network relationships with the target user is directly used as the optimized and adjusted credit score of the target user, or any value between an average value of the credit scores of all other users having the social-network relationships with the target user and the initial credit score of the target user is used as the optimized and adjusted credit score of the target user.

Further, in an embodiment, the optimization apparatus for obtaining a user credit score may determine, according to the social-network relationship between the target user and each of the other users in a same social-network user set, a social weight between the other user and the target user, and then optimize and adjust, according to the social weight between each of the other users belonging to the same social-network user set and the target user and a credit score of the corresponding user, the credit score of the target user. The social weight may be a result of quantifying a closeness degree of a social-network relationship between two users.

For example, the closeness degree of the social-network relationship between the two users is quantified by calculating the number of common social friends of the two users, social-network groups in which the two users jointly participate, social events in which the two users jointly participate, the frequency of social events occurring between the two users, or the like, to obtain the social weight between the two users. If the social-network relationship between the two users is closer, a probability that the credit scores of the two users are similar is higher. In other words, a credit score of a user close to the target user likely reflects the credit score of the target user.

Therefore, when the credit score of the target user is optimized and adjusted, an impact factor (a reference weight) of the credit score of a user close to the target user should be set to a larger value. The credit score of the target social-network user set is optimized and adjusted according to the credit score of each of the other users in the target social-network user set and the social weight between the user and the target user, for example,

$${q}_{i} = {\sum }_{k ∈ Nb ( i )} {w}_{ki} * {q}_{k} ,$$

where qᵢ is the credit score of the target user, qₖ is the credit score of a k^{th} user having the social-network relationship with the target user, wₖᵢ is the social weight between the k^{th} user and the target user, and

$${\sum }_{k ∈ Nb ( i )} {w}_{ki} * {q}_{k}$$

represents a sum of all products of the credit score of each user that is in the target social-network user set and that has the social-network relationship with the target user and the social weight between the corresponding user and the target user.

This implementation is especially applicable to a situation in which a new target user is added to the target social-network user set while other users are all optimized and adjusted, so that only target user is separately optimized and adjusted without optimizing and adjusting other users in the target social-network user set again.

In another embodiment, the optimization apparatus for obtaining a user credit score may optimize and iterate, according to the credit scores of the users in a social-network user set and a social-network relationship between the users in the social-network user set, the credit score of a user in the social-network user set; and in each iteration, separately use each user in the target social-network user set as the target user, and optimize and adjust, according to the social weight between each of the other users in the target social-network user set and the target user and the credit score of the corresponding user, the credit score of the target user, and stop the iteration when a difference between the credit score of each user in the target social-network user set in this iteration and a credit score of the user in a previous iteration is less than a second preset value, so that an obtained credit score of the user is the credit score obtained by means of optimization and adjustment. A specific iteration procedure may be shown in FIG. 5, and includes the following steps.

S2061: Determining a social weight between each two users in the target social-network user set according to a social-network relationship between each two users.

A social weight between any two users in a same social-network user set may be determined according to a social-network relationship between the two users. The social weight may be a result of quantifying a closeness degree of a social-network relationship between two users. For example, the closeness degree of the social-network relationship between the two users is quantified by calculating the number of common social friends of the two users, social-network groups in which the two users jointly participate, social events in which the two users jointly participate, the frequency of social events occurring between the two users, or the like, to obtain the social weight between the two users.

S2062: Optimizing and iterating the credit scores of the social-network user sets.

S2063: Separately using each of the multiple social-network user sets as a target social-network user set and, according to the social weight between the at least one social-network user set and the target social-network user set and the credit score of the corresponding social-network user set, optimizing and adjusting the credit score of the target social-network user set.

That is, in each iteration, the credit score of each user in the target social-network user set is optimized and adjusted by using the following formula:

$${q}_{i}^{( r )} = λ + ( 1 - λ ) {\sum }_{k ∈ Nb ( i )} {w}_{ki} * {q}_{k}^{( r - 1 )} ,$$

where qᵢ^{(r)} is the credit score of an i^{th} user in an r^{th} round of iteration, qₖ^{(r-1)} is the credit score of a user having the social-network relationship with the i^{th} user in the target social-network user set in a (r−1)^{th} round of iteration, wₖᵢ is the social weight between the user having the social-network relationship with the i^{th} user in the target social-network user set and the i^{th} user,

$${\sum }_{k ∈ Nb ( i )} {w}_{ki} * {q}_{k}^{( r - 1 )}$$

represents a sum of all products of the credit score of each user having the social-network relationship with the i^{th} user in the target social-network user set and the social weight between the corresponding user and the i^{th} user, and λ is a preset damping factor.

S2064: Determining whether an absolute value of a difference between the credit score of each user in the target social-network user set in this iteration and a credit score of the user in a previous iteration is less than a first preset value, that is, ∀i,|qᵢ^{(r)}−qᵢ^{(r-1)}|<γ, and, if the formula is satisfied, performing S2065, otherwise performing S2062, that is, a next iteration.

S2065: Stopping the iteration, and the credit score of each social-network user set obtained by means of iteration is the credit score of the social-network user set obtained by means of optimization and adjustment.

It should be noted that the foregoing descriptions are only an example of an iteration algorithm. An algorithm for iterating the credit score of the social-network user set in the present disclosure should not be considered to be limited to the algorithm, and other algorithms such as a heat conduction network iteration algorithm may be applicable.

Further, in an embodiment, the optimization apparatus for obtaining a user credit score may push product information for a user according to the corrected credit score of the corresponding user that is obtained by performing the steps in one embodiment, for example, push financial product information or fixed assets management product information; or monitor and manage a data service of a user according to the credit score of the corresponding user, for example, perform risk management on a loan service of the corresponding user, or propose a suggestion on management of current funds of the user.

In one embodiment, after calculating a credit score of a social-network user set to which a user belongs and optimizing and adjusting the credit score of the social-network user set according to a social-network relationship between social-network user sets, the optimization apparatus for obtaining a user credit score corrects credit scores of users in the social-network user set according to the optimized and adjusted credit score of the social-network user set, and optimizes and adjusts the credit scores of the users in the social-network user set according to a social-network relationship between the users in the social-network user set, to optimize the credit scores of the users in combination of information of the social-network user set. Calculating the credit scores of the users is no longer according to only personal information of the users, so that the accuracy of the credit scores of the users can be effectively increased. Moreover, although the optimization process is performed twice, the two optimizations are separately performed based on the social-network relationship between the social-network user sets and the social-network relationship between users in the social-network user set, and do not require a large amount of calculation.

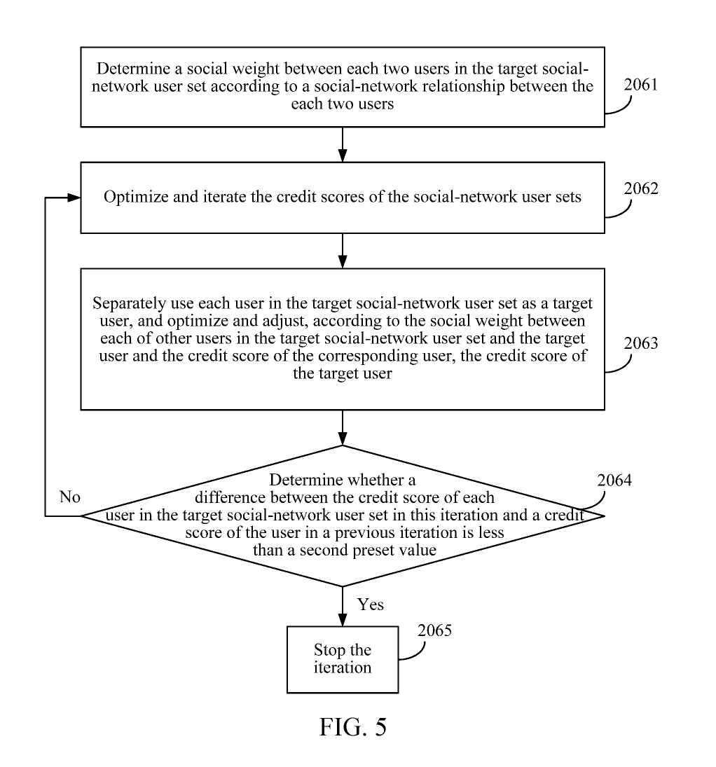

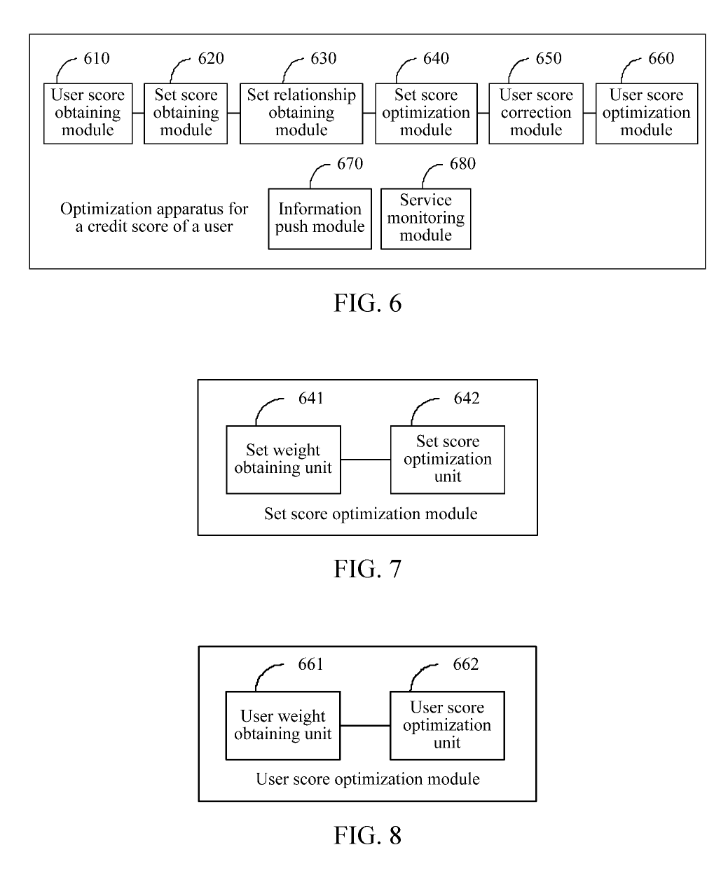

FIG. 6 is a schematic structural diagram of an optimization apparatus for obtaining a user credit score according to an embodiment of the present disclosure. As shown in the figure, in one embodiment, the optimization apparatus for obtaining a user credit score may include a user score obtaining module 610, a set score obtaining module 620, a set relationship obtaining module 630, a set score optimization module 640, a user score correction module 650, a user score optimization module 660, an information push module 670, and a service monitoring module 680.

The user score obtaining module 610 is configured to obtain initial credit scores of users in multiple social-network user sets.

Specifically, the user score obtaining module 610 may obtain the initial credit scores of the users in the multiple social-network user sets by receiving imported data. Alternatively, the user score obtaining module 610 may obtain personal information of the users, and perform credit scoring according to the personal information of the users and a specific predictive model, to obtain the initial credit scores of the users in the multiple social-network user sets. Alternatively, the user score obtaining module 610 may obtain optimized credit scores of the users by implementing the present disclosure, and use the optimized credit scores as the initial credit scores of the users in the multiple social-network user sets. For example, when current credit scores are optimized, credit scores of the users that are obtained in a previous optimization may be used as initial credit scores in this optimization. The optimizing the credit scores of the users may be manually triggered by an administrator, or may be triggered according to an updating cycle or according to an event of adding a new user or social-network user set.

In an embodiment, if an initial credit score of a user is missing, the user score obtaining module 610 may use an average score or a weighted average score of credit scores of users who are social friends, colleagues, and relatives of the user as the initial credit score of the user. A weighted value may be determined according to a closeness degree between a user and the user or according to a frequency of a social event occurring between a user and the user.

The multiple social-network user sets may be sets of the users participating in different social-network groups. Users participating in a same social-network group belong to a social-network user set corresponding to the social-network group. Alternatively, the multiple social-network user sets may be obtained by performing division according to specific attributes of the users, for example, interests or geographical locations of the users. In one embodiment, in the social-network user sets, a same user does not exist in more than one set. That is, one user belongs to only one social-network user set.

The set score obtaining module 620 is configured to obtain initial credit scores of the social-network user sets according to the initial credit scores of the users in the social-network user sets.

In a specific implementation, the set score obtaining module 620 may use an average score or a weighted average score of the initial credit scores of the users in a social-network user set as an initial credit score of the social-network user set.

The weight value of each user may be determined according to a social-network relationship between the user and a user in the social-network user set. For example, a user has four social friends in a social-network user set (six persons in total), and the weight value may be 4/(6−1)=0.8, and so on. Alternatively, the weight value of a user used for the credit score of the social-network user set may be determined according to a frequency of social events (for example, sending a session message or performing a video session) occurring between the user and other users in the social-network user set. Alternatively, a weight value of a user for the credit score of a social-network user set to which the user belongs may be jointly determined in combination with the foregoing two manners.

The set relationship obtaining module 630 is configured to determining a social-network relationship between each two social-network user sets according to a social-network relationship between the users in each two social-network user sets.

The set relationship obtaining module 630 may determine a social-network relationship between two social-network user sets according to social-network relationships between the users separately belonging to the two social-network user sets. For example, if a first user belonging to a first social-network user set has a social friend in a second social-network user set, a social-network relationship exists between the first social-network user set and the second social-network user set. Then, the set relationship obtaining module 630 may further quantify a closeness degree of the social-network relationship between the two social-network user sets. For example, the closeness degree of the social-network relationship between the two social-network user sets may be quantified according to the number of users that are in the two social-network user sets and that are social friends of each other (the number of users or the number of social-network relationship pairs). The closeness degree may be consistent, that is, a bi-directional closeness degree between the two social-network user sets is quantified, or may be inconsistent, that is, a unidirectional closeness degree between the two social-network user sets is quantified.

For example, social-network user sets (also referred to as associations) A, B, C, and D are obtained by means of layered processing of social-network relationships between users that is shown in FIG. 2. The number of users that are in the social-network user set A and that have social friends in the social-network user set B is determined, and the result of dividing the number of users having the social friends in the social-network user set B by a total number of users in the social-network user set A as a social closeness degree of the social-network user set A with the social-network user set B.

On the reversing direction, the result of dividing the number of users having social friends in the social-network user set A by a total number of users in the social-network user set B as a social closeness degree of the social-network user set B with the social-network user set A. A bi-directional closeness degree between the social-network user set A and the social-network user set B may be further calculated according to the social closeness degree of the social-network user set A with the social-network user set B in combination with the social closeness degree of the social-network user set B with the social-network user set A.

Subsequently, a social weight between the two social-network user sets may also be determined according to the closeness degree of the social-network relationship between the two social-network user sets that is obtained by means of quantification. That is, when a credit score of a target social-network user set is calculated, a weight value of the credit score of the other social-network user set having the social-network relationship with the target social-network user set is considered. If the social-network relationship between two social-network user sets is closer, the probability that credit scores of the two social-network user sets are similar is higher. In other words, a credit score of a close social-network user set of the target social-network user set likely reflects the credit score of the target social-network user set. Therefore, when the credit score of the target social-network user set is optimized and adjusted, an impact factor (a reference weight) of the credit score of a close social-network user set should be set to a larger value.

In the layered processing of the social-network relationships shown in FIG. 2, social-network relationships between associations of a middle layer are obtained by performing processing according to cross-association (social-network user set) social-network relationships of users in original social-network relationships of an upper layer, and social-network relationships between users in an association are reserved as social-network relationships of the users in a lower-layer association.

The set score optimization module 640 is configured to: optimize and adjust, according to a credit score of at least one social-network user set having a social-network relationship with a target social-network user set and the social-network relationship between the at least one social-network user set and the target social-network user set, a credit score of the target social-network user set.

According to the social-network relationship between each two social-network user sets that is obtained by the set relationship obtaining module 630, it may be considered that, the two social-network user sets having the social-network relationship may affect each other, or credit scores of the two social-network user sets having the social-network relationship may be used as reference of each other. Therefore, the set score optimization module 640 may optimize and adjust the credit score of the target social-network user set according to credit scores of all other social-network user sets having social-network relationships with the target social-network user set, to effectively avoid inaccurate credit score of the target social-network user set caused by that information of the user is collected incompletely or mistakenly. For example, the set score optimization module 640 may directly use an average value of the credit scores of the other social-network user sets having the social-network relationships with the target social-network user set as the optimized and adjusted credit score of the target social-network user set, or use any value between an average value of the credit scores of the other social-network user sets having the social-network relationships with the target social-network user set and the initial credit score of the target social-network user set as the optimized and adjusted credit score of the target social-network user set.

Further, in an embodiment, as shown in FIG. 7, the set score optimization module 640 further includes a set weight obtaining unit 641 and a set score optimization unit 642.

The set weight obtaining unit 641 is configured to separately determine a social weight between each social-network user set and the target social-network user set according to the social-network relationship between the social-network user set and the target social-network user set. For example, the social weight between each social-network user set and the target social-network user set may be determined according to a ratio of users each having a social-network-associated user in the social-network user sets to the users in the target social-network user set.

The set score optimization unit 642 is configured to: according to the social weight between the at least one social-network user set and the target social-network user set and the credit score of the corresponding social-network user set, optimize and adjust the credit score of the target social-network user set.

That is, the social weight between each social-network user set and the target social-network user set is determined according to the closeness degree that is between the target social-network user set and each of the other social-network user sets and that is obtained by quantification, and then the credit score of the target social-network user set is optimized and adjust according to the credit score of each social-network user set having the social-network relationship with the target social-network user set and the social weight between the social-network user set and the target social-network user set, for example,

$${Q}_{i} = {\sum }_{k ∈ Nb ( i )} {e}_{ki} * {Q}_{k} ,$$

where Qᵢ is the credit score of the target social-network user set, Qₖ is a credit score of k^{th} social-network user set having a social-network relationship with the target social-network user set, eₖᵢ is the social weight between the k^{th} social-network user set and the target social-network user set, and

$${\sum }_{k ∈ Nb ( i )} {e}_{ki} * {Q}_{k}$$

represents a sum of products of a credit score of each social-network user set having a social-network relationship with the target social-network user set and the social weight between the corresponding social-network user set and the target social-network user set. This implementation is especially applicable to a situation in which a new target social-network user set is added while other social-network user sets are all optimized and adjust, so that the set score optimization module 640 may only optimize and adjust the target social-network user set separately without optimizing and adjusting other social-network user sets again.

In another embodiment, the set score optimization unit 642 may optimize and iterate, according to a credit score of at least one social-network user set having a social-network relationship with a target social-network user set and the social-network relationship between the at least one social-network user set and the target social-network user set, credit scores of the social-network user sets. A specific iteration procedure may be shown in FIG. 3, and specifically includes: optimizing and iterating the credit scores of the social-network user sets; and in each iteration, separately using each of the multiple social-network user sets as the target social-network user set, optimizing and adjusting, according to a social weight between the at least one social-network user set and the target social-network user set and the credit score of the corresponding social-network user set, the credit score of the target social-network user set, and stopping the iteration after a difference between the credit score of each of the multiple social-network user sets in this iteration and a credit score of the social-network user set in a previous iteration is less than a first preset value, so that an obtained credit score of the social-network user set is the credit score obtained by means of optimization and adjustment. For example, the set score optimization unit 642 iterates the credit score of each of the multiple social-network user sets by using the following formula:

$${Q}_{i}^{( r )} = α + ( 1 - α ) {\sum }_{k ∈ Nb ( i )} {e}_{ki} * {Q}_{k}^{( r - 1 )} ,$$

where Qᵢ^{(r)} is the credit score of an i^{th} social-network user set in an r^{th} round of iteration, Qₖ^{(r-1)} is the credit score of a social-network user set having the social-network relationship with the i^{th} social-network user set in a (r−1)^{th} round of iteration, eₖᵢ is the social weight between the social-network user set having the social-network relationship with the i^{th} social-network user set and the i^{th} social-network user set,

$${\sum }_{k ∈ Nb ( i )} {e}_{ki} * {Q}_{k}^{( r - 1 )}$$

represents a sum of all products of the credit score of each social-network user set having the social-network relationship with the i^{th} social-network user set and the social weight between the corresponding social-network user set and the i^{th} social-network user set, and α is a preset damping factor.

It should be noted that the foregoing descriptions are only an example of an iteration algorithm. An algorithm for iterating the credit score of the social-network user set in the present disclosure should not be considered to be limited to the algorithm, and other algorithms such as a heat conduction network iteration algorithm may be applicable.

The user score correction module 650 is configured to correct credit scores of the users in the target social-network user set according to the optimized and adjusted credit score of the target social-network user set.

Specifically, the user score correction module 650 may correct the credit score of a user in the target social-network user set to any value between the initial credit score of the corresponding user and the optimized and adjusted credit score of the target social-network user set. For example, if information of a user in the target social-network user set is missing or goes wrong, the user score correction module 650 may use the optimized and adjusted credit score of the target social-network user set as the corrected credit score of the user.

In an embodiment, the user score correction module 650 may correct the credit scores of the users in the target social-network user set according to an adjustment value for optimizing and adjusting the credit score of the target social-network user set. For example, the credit scores of the users in the target social-network user set are corrected by using the following formula:

sⱼ′=sⱼ+(Qᵢ−Sᵢ),

where Qᵢ is the optimized and adjusted credit score of the target social-network user set, Sᵢ is the initial credit score of the target social-network user set, sⱼ is the initial credit score of a j^{th} user in the target social-network user set, and sⱼ′ is the corrected credit score of the j^{th} user in the target social-network user set.

The user score correction module 650 may alternatively correct a corresponding ratio of the credit scores of the users in the target social-network user set according to an adjustment ratio for optimizing and adjusting the credit score of the target social-network user set.

In an embodiment, the optimization apparatus for obtaining a user credit score may further include the user score optimization module 660, which is configured to: optimize and adjust, according to a social-network relationship between a target user and each of other users in the target social-network user set and the credit scores of the other users in the target social-network user set, the credit score of the target user.

Social-network relationships between users in a lower-layer association are obtained by means of layered processing of social-network relationships that is shown in FIG. 2, for example, social-network relationships between users a1, a2, and a3 in a social-network user set A. In an embodiment, a reason for dividing the users a1, a2, and a3 into the social-network user set A may be excluded. For example, the users a1, a2, and a3 are divided into the social-network user set A according to a same social-network group in which the three users participate, and when the social-network relationships between the users a1, a2, and a3 are considered, information that the users a1, a2, and a3 participate in a same social-network group may be ignored, and the social-network relationships between the users a1, a2, and a3 may be determined based on a factor, for example, whether a social friend relationship is established between the users, whether the users have a common interest, whether the users participate in social events at the same time, or whether the users are located in a same geographical location, etc.

If two users in a same social-network user set have a social-network relationship, it may be considered that the two users having the social-network relationship affect each other, or credit scores of the two users having the social-network relationship may be used as reference of each other. Therefore, the user score optimization module 660 may optimize and adjust the credit score of the target user according to a credit score of another user that belongs to a same social-network user set and that has a social-network relationship with the target user, thereby effectively avoiding the problem of inaccurate credit score of the target user when the information of the user is collected incompletely or mistakenly. For example, an average value of the credit scores of all other users having the social-network relationships with the target user is directly used as the optimized and adjusted credit score of the target user, or any value between an average value of the credit scores of all other users having the social-network relationships with the target user and the initial credit score of the target user is used as the optimized and adjusted credit score of the target user.

Further, in an embodiment, as shown in FIG. 8, the user score optimization module 660 may further include a user weight obtaining unit 661 and a user score optimization unit 662.

The user weight obtaining unit 661 is configured to determine a social weight between each of the other users in the target social-network user set and the target user according to the social-network relationship between the target user and the user in the target social-network user set.

The social weight may be a result of quantifying a closeness degree of a social-network relationship between two users. For example, the closeness degree of the social-network relationship between the two users is quantified by calculating the number of common social friends of the two users, social-network groups in which the two users jointly participate, social events in which the two users jointly participate, the frequency of social events occurring between the two users, or the like, to obtain the social weight between the two users.

The user score optimization unit 662 is configured to: optimize and adjust, according to the social weight between each of the other users in the target social-network user set and the target user and the credit score of the corresponding user, the credit score of the target user.

If the social-network relationship between the two users is closer, a probability that the credit scores of the two users are similar is higher. In other words, a credit score of a user close to the target user likely reflects the credit score of the target user. Therefore, when the credit score of the target user is optimized and adjusted, an impact factor (the social weight) of the credit score of a user close to the target user may be set to a larger value. The user score optimization unit 662 optimizes and adjusts, according to the credit score of each of the other users in the target social-network user set and the social weight between the user and the target user, the credit score of the target social-network user set, for example,

$${q}_{i} = {\sum }_{k ∈ Nb ( i )} {w}_{ki} * {q}_{k} ,$$

where qᵢ is the credit score of the target user, qₖ is the credit score of a k^{th} user having the social-network relationship with the target user, wₖᵢ is the social weight between the k^{th} user and the target user, and

$${\sum }_{k ∈ Nb ( i )} {w}_{ki} * {q}_{k}$$

represents a sum of all products of the credit score of each user that is in the target social-network user set and that has the social-network relationship with the target user and the social weight between the corresponding user and the target user. This implementation is especially applicable to a situation in which a new target user is added to the target social-network user set while other users are all optimized and adjusted, so that only target user is separately optimized and adjusted without optimizing and adjusting other users in the target social-network user set again.

In another embodiment, the user score optimization unit 662 may optimize and iterate, according to the credit scores of the users in a social-network user set and the social-network relationships between the users in the social-network user set, the credit scores of the users in the social-network user set. A specific iteration procedure may be shown in FIG. 5, and includes: in each iteration, separately using each user in the target social-network user set as the target user, optimizing and adjusting, according to the social weight between each of the other users in the target social-network user set and the target user and the credit score of the corresponding user, the credit score of the target user, and stopping the iteration after a difference between the credit score of each user in the target social-network user set in this iteration and a credit score of the user in a previous iteration is less than a second preset value, so that an obtained credit score of the user is the credit score obtained by means of optimization and adjustment. For example, the user score optimization unit 662 may optimize and adjust the credit scores of the users in the target social-network user set by using the following formula:

$${q}_{i}^{( r )} = λ + ( 1 - λ ) {\sum }_{k ∈ Nb ( i )} {w}_{ki} * {q}_{k}^{( r - 1 )} ,$$

where qᵢ^{(r)} is the credit score of an i^{th} user in an r^{th} round of iteration, qₖ^{(r-1)} is the credit score of a user having the social-network relationship with the i^{th} user in the target social-network user set in a (r−1)^{t} round of iteration, wₖᵢ is the social weight between the user having the social-network relationship with the i^{th} user in the target social-network user set and the i^{th} user,

$${\sum }_{k ∈ Nb ( i )} {w}_{ki} * {q}_{k}^{( r - 1 )}$$

represents a sum of all products of the credit score of each user having the social-network relationship with the i^{th} user in the target social-network user set and the social weight between the corresponding user and the i^{th} user, and λ is a preset damping factor.

It should be noted that the foregoing descriptions are only an example of an iteration algorithm. An algorithm for iterating the credit score of the social-network user set in the present disclosure should not be considered to be limited to the algorithm, and other algorithms such as a heat conduction network iteration algorithm may be applicable.

In one embodiment of the present disclosure, the apparatus may further include any one or two of an information push module 670 and a service monitoring module 680.

The information push module 670 is configured to push product information for a user according to the credit score of the corresponding user, that is, to push the product information for the corresponding user according to the credit score of the user that is corrected or optimized by using the implementation of the present disclosure, for example, push financial product information or fixed assets management product information.

The service monitoring module 680 is configured to monitor and manage a data service of a user according to the credit score of the corresponding user, that is, monitor and manage the data service of the user according to the credit score of the corresponding user that is corrected or optimized by using the implementation of the present disclosure, for example, perform risk management on a loan service of the corresponding user or propose a suggestion on management of current funds of the user.

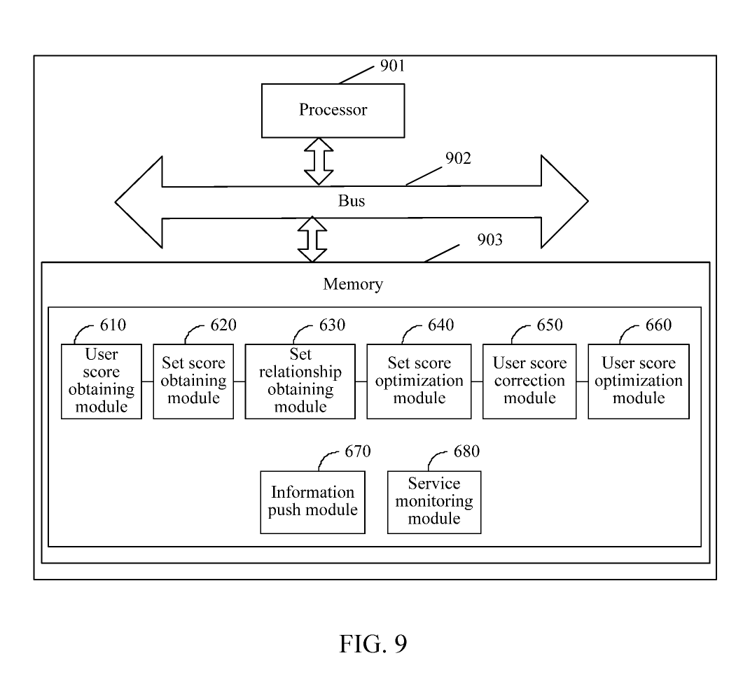

FIG. 9 is a block diagram of a hardware structure of an optimization apparatus for obtaining a user credit score according to an embodiment of the present disclosure. The apparatus may include a processor 901, a bus 902, and a memory 903. The processor 901 and the memory 903 are interconnected by using the bus 902.

The memory 903 stores a user score obtaining module 610, a set score obtaining module 620, a set relationship obtaining module 630, a set score optimization module 640, a user score correction module 650, a user score optimization module 660, an information push module 670, and a service monitoring module 680.

When being performed by the processor 901, operations performed by the modules stored in the memory 903 are the same as those in the foregoing embodiment, and details are not described herein again.

In one embodiment, after calculating a credit score of a social-network user set to which a user belongs and optimizing and adjusting the credit score of the social-network user set according to a social-network relationship between social-network user sets, the optimization apparatus for obtaining a user credit score corrects credit scores of users in the social-network user set according to the optimized and adjusted credit score of the social-network user set, and may optimize and adjust the credit scores of the users in the social-network user set according to a social-network relationship between the users in the social-network user set, to optimize the credit scores of the users in combination of information of the social-network user set. Calculating the credit scores of the users is no longer according to only personal information of the users, so that the accuracy of the credit scores of the users can be effectively increased.

A person of ordinary skill in the art may understand that all or some of the processes of the methods in the embodiments may be implemented by a computer program instructing relevant hardware. The program may be stored in a computer-readable storage medium. When the program runs, the processes of the methods in the embodiments are performed. The storage medium may be: a magnetic disk, an optical disc, a read-only memory (ROM), a random-access memory (RAM), or the like.

What is disclosed above is merely preferred embodiments of the present disclosure, and certainly is not intended to limit the protection scope of the present disclosure. Therefore, equivalent variations made in accordance with the claims of the present disclosure shall fall within the scope of the present disclosure.

What is claimed is:

1. An optimization method for obtaining a user credit score, the method comprising:
obtaining initial credit scores of users in multiple social-network user sets;
obtaining initial credit scores of the social-network user sets according to the initial credit scores of the users in the social-network user sets;
determining a social-network relationship between each two social-network user sets according to a social-network relationship between the users in the each two social-network user sets;
according to a credit score of at least one social-network user set having a social-network relationship with a target social-network user set and the social-network relationship between the at least one social-network user set and the target social-network user set, optimizing and adjusting a credit score of the target social-network user set; and
correcting credit scores of users in the target social-network user set according to the optimized and adjusted credit score of the target social-network user set.

2. The optimization method for obtaining a user credit score according to claim 1, wherein, after the correcting credit scores of the users in the target social-network user set according to the optimized and adjusted credit score of the target social-network user set, the method further comprises:
according to a social-network relationship between a target user and each of other users in the target social-network user set and credit scores of the other users in the target social-network user set, optimizing and adjusting the credit score of the target user.

3. The optimization method for obtaining a user credit score according to claim 1, wherein the optimizing and adjusting a credit score of the target social-network user set comprises:
determining a social weight between each social-network user set and the target social-network user set according to the social-network relationship between the social-network user set and the target social-network user set; and
according to the social weight between the at least one social-network user set and the target social-network user set and the credit score of the corresponding social-network user set, optimizing and adjusting the credit score of the target social-network user set.

4. The optimization method for obtaining a user credit score according to claim 3, wherein the determining a social weight between each social-network user set and the target social-network user set according to the social-network relationship between the social-network user sets and the target social-network user set comprises:
determining the social weight between each social-network user set and the target social-network user set according to a ratio of a ratio between users having a social-network-associated user in each of the social-network user sets and the total users in the target social-network user set.

5. The optimization method for obtaining a user credit score according to claim 3, wherein the optimizing and adjusting the credit score of the target social-network user set comprises:
optimizing and iterating the credit scores of the social-network user sets, including:
in each iteration, separately using each of the multiple social-network user sets as the target social-network user set to perform optimizing and adjusting, according to the social weight between the at least one social-network user set and the target social-network user set and the credit score of the corresponding social-network user set, the credit score of the target social-network user set, and
stopping the iteration after a difference between the credit score of each of the multiple social-network user sets in this iteration and a credit score of the social-network user set in a previous iteration is less than a first preset value, so that an obtained credit score of the social-network user set is the credit score optimized and adjusted.

6. The optimization method for obtaining a user credit score according to claim 5, wherein the optimizing and iterating credit scores of the social-network user sets comprises:
iterating the credit score of each of the multiple social-network user sets by using the following formula:
$${Q}_{i}^{( r )} = α + ( 1 - α ) {\sum }_{k ∈ Nb ( i )} {e}_{ki} * {Q}_{k}^{( r - 1 )} ,$$
wherein Qᵢ^{(r)} is the credit score of an i^{th} social-network user set in an r^{th} round of iteration, Qₖ^{(r-1)} is the credit score of a social-network user set having the social-network relationship with the i^{th} social-network user set in a (r−1)^{th} round of iteration, eₖᵢ is the social weight between the social-network user set having the social-network relationship with the i^{th} social-network user set and the i^{th} social-network user set,
$${\sum }_{k ∈ Nb ( i )} {e}_{ki} * {Q}_{k}^{( r - 1 )}$$
represents a sum of all products of the credit score of each social-network user set having the social-network relationship with the i^{th} social-network user set and the social weight between the corresponding social-network user set and the i^{th} social-network user set, and α is a preset damping factor.

7. The optimization method for obtaining a user credit score according to claim 2, wherein the optimizing and adjusting the credit score of the target user comprises:
determining a social weight between each of the other users in the target social-network user set and the target user according to the social-network relationship between the target user and the user in the target social-network user set, and
according to the social weight between each of the other users in the target social-network user set and the target user and the credit score of the corresponding user, optimizing and adjusting the credit score of the target user.

8. The optimization method for obtaining a user credit score according to claim 7, wherein the optimizing and adjusting the credit score of the target user comprises:
optimizing and iterating the credit scores of the users in the target social-network user set, including:
in each iteration, separately using each user in the target social-network user set as the target user to optimize and adjust, according to the social weight between each of the other users in the target social-network user set and the target user and the credit score of the corresponding user, the credit score of the target user, and
stopping the iteration after a difference between the credit score of each user in the target social-network user set in this iteration and a credit score of the user in a previous iteration is less than a second preset value, so that an obtained credit score of the user is the credit score optimized and adjusted.

9. The optimization method for obtaining a user credit score according to claim 8, wherein the optimizing and iterating the credit scores of the users in the target social-network user set comprises:
iterating the credit score of each user in the target social-network user set by using the following formula:
$${q}_{i}^{( r )} = λ + ( 1 - λ ) {\sum }_{k ∈ Nb ( i )} {w}_{ki} * {q}_{k}^{( r - 1 )} ,$$
wherein qᵢ^{(r)} is the credit score of an i^{th} user in an r^{th} round of iteration, qₖ^{(r-1)} is the credit score of a user having the social-network relationship with the i^{th} user in the target social-network user set in a (r−1)^{t} round of iteration, wₖᵢ is the social weight between the user having the social-network relationship with the i^{th} user in the target social-network user set and the i^{th} user,
$${\sum }_{k ∈ Nb ( i )} {w}_{ki} * {q}_{k}^{( r - 1 )}$$
represents a sum of all products of the credit score of each user having the social-network relationship with the i^{th} user in the target social-network user set and the social weight between the corresponding user and the i^{th} user, and λ is a preset damping factor.

10. The optimization method for obtaining a user credit score according to claim 1, wherein the correcting credit scores of the users in the target social-network user set according to the optimized and adjusted credit score of the target social-network user set comprises:
correcting the credit scores of the users in the target social-network user set according to an adjustment value for optimizing and adjusting the credit score of the target social-network user set.

11. The optimization method for obtaining a user credit score according to claim 10, wherein the correcting the credit scores of the users in the target social-network user set according to an adjustment value for optimizing and adjusting the credit score of the target social-network user set comprises:
correcting the credit scores of the users in the target social-network user set by using the following formula:
sⱼ′=sⱼ+(Qᵢ−Sᵢ),
wherein Qᵢ is the optimized and adjusted credit score of the target social-network user set, Sᵢ is the initial credit score of the target social-network user set, sⱼ is the initial credit score of a j^{th} user in the target social-network user set, and sⱼ′ is the corrected credit score of the j^{th} user in the target social-network user set.

12. The optimization method for obtaining a user credit score according to claim 1, further comprising:
pushing product information for a user according to the credit score of the corresponding user; or
monitoring and managing a data service of a user according to the credit score of the corresponding user.

13. A non-transitory computer-readable storage medium storing computer program instructions executable by at least one processor to perform:
obtaining initial credit scores of users in multiple social-network user sets;
obtaining initial credit scores of the social-network user sets according to the initial credit scores of the users in the social-network user sets;
determining a social-network relationship between each two social-network user sets according to a social-network relationship between the users in the each two social-network user sets;
according to a credit score of at least one social-network user set having a social-network relationship with a target social-network user set and the social-network relationship between the at least one social-network user set and the target social-network user set, optimizing and adjusting a credit score of the target social-network user set; and
correcting credit scores of users in the target social-network user set according to the optimized and adjusted credit score of the target social-network user set.

14. The non-transitory computer-readable storage medium according to claim 13, wherein, after the correcting credit scores of the users in the target social-network user set according to the optimized and adjusted credit score of the target social-network user set, the processor is further configured to perform:
according to a social-network relationship between a target user and each of other users in the target social-network user set and credit scores of the other users in the target social-network user set, optimizing and adjusting the credit score of the target user.

15. The non-transitory computer-readable storage medium according to claim 13, wherein the optimizing and adjusting a credit score of the target social-network user set comprises:
determining a social weight between each social-network user set and the target social-network user set according to the social-network relationship between the social-network user set and the target social-network user set; and
according to the social weight between the at least one social-network user set and the target social-network user set and the credit score of the corresponding social-network user set, optimizing and adjusting the credit score of the target social-network user set.

16. The non-transitory computer-readable storage medium according to claim 15, wherein the determining a social weight between each social-network user set and the target social-network user set according to the social-network relationship between the social-network user sets and the target social-network user set comprises:
determining the social weight between each social-network user set and the target social-network user set according to a ratio of a ratio between users having a social-network-associated user in each of the social-network user sets and the total users in the target social-network user set.

17. The non-transitory computer-readable storage medium according to claim 15, wherein the optimizing and adjusting the credit score of the target social-network user set comprises:
optimizing and iterating the credit scores of the social-network user sets, including:
in each iteration, separately using each of the multiple social-network user sets as the target social-network user set to perform optimizing and adjusting, according to the social weight between the at least one social-network user set and the target social-network user set and the credit score of the corresponding social-network user set, the credit score of the target social-network user set, and
stopping the iteration after a difference between the credit score of each of the multiple social-network user sets in this iteration and a credit score of the social-network user set in a previous iteration is less than a first preset value, so that an obtained credit score of the social-network user set is the credit score optimized and adjusted.

18. The non-transitory computer-readable storage medium according to claim 14, wherein the optimizing and adjusting the credit score of the target user comprises:
determining a social weight between each of the other users in the target social-network user set and the target user according to the social-network relationship between the target user and the user in the target social-network user set, and
according to the social weight between each of the other users in the target social-network user set and the target user and the credit score of the corresponding user, optimizing and adjusting the credit score of the target user.

19. The non-transitory computer-readable storage medium according to claim 18, wherein the optimizing and adjusting the credit score of the target user comprises:
optimizing and iterating the credit scores of the users in the target social-network user set, including:
in each iteration, separately using each user in the target social-network user set as the target user to optimize and adjust, according to the social weight between each of the other users in the target social-network user set and the target user and the credit score of the corresponding user, the credit score of the target user, and
stopping the iteration after a difference between the credit score of each user in the target social-network user set in this iteration and a credit score of the user in a previous iteration is less than a second preset value, so that an obtained credit score of the user is the credit score optimized and adjusted.

20. The non-transitory computer-readable storage medium according to claim 13, wherein the processor is further configured to perform:
pushing product information for a user according to the credit score of the corresponding user; or
monitoring and managing a data service of a user according to the credit score of the corresponding user.
